(19) United States
(12) Patent Application Publication
(10) Pub. No.: US 2025/0126682 A1
(43) Pub. Date: Apr. 17, 2025

(54) ALL-CERAMIC HEATING ELEMENT

(71) Applicant: CHONGQING LE-MARK TECHNOLOGY CO., LTD., Chongqing (CN)

(72) Inventor: Peter LEIGH, Chongqing (CN)

(21) Appl. No.: 18/688,549

(22) PCT Filed: Sep. 16, 2022
(86) PCT No.: PCT/CN2022/119172

§ 371 Date: Mar. 1, 2024

(30) Foreign Application Priority Data
Mar. 30, 2022 (CN) 202210328351.X

(51) Int. Cl. H05B 3/14; H05B 3/16

(52) U.S. Cl. CPC H05B 3/141; H05B 3/16; H05B 2203/01

(57) ABSTRACT

The present application relates to the technical field of electric heating elements, and discloses an all-ceramic heating element, which includes an outer heating layer, an inner insulating layer (3) and an inner heating layer, wherein the inner heating layer, the inner insulating layer (3) and the outer heating layer are sequentially arranged from inside to outside; the outer heating layer is electrically connected to the inner heating layer; and the weight ratio of ceramic materials of an outer resistive layer (4) and an inner resistive layer (2) is: silicon nitride:silicon carbide:aluminum oxide:yttrium oxide:lanthanum oxide:molybdenum disilicide=(500-700):(100-300):(40-80):(50-90):(0-30):(500-800), and the ratios thereof for the outer resistive layer (4) and the inner resistive layer (2) are different. The heating element has integrated heating and temperature-sensing functions, is not affected by an external environment, can realize reliable heating or ignition, and has a reliable service life.

### CROSS-REFERENCE TO RELATED APPLICATIONS

This application is a national stage entry application under 35 U.S.C. 371 of PCT Patent Application No. PCT/CN2022/119172, filed on Sep. 16, 2022, which claims priority to Chinese Patent Application No. 202210328351.X filed on Mar. 30, 2022, the entire contents of each of which are incorporated herein by reference.

### TECHNICAL FIELD

The present disclosure relates to the technical field of electric heating elements, and in particular, to an all-ceramic heating element.

### BACKGROUND

Electric heating elements are widely applied in heating or ignition equipments, such as instant-heating dual-mode water heaters, automotive exhaust gas oxidation sensors, industrial equipment heating devices, ultrasonic electric heating elements, mold heating and heat preservation devices, medical instrument heaters, air heaters, small heating appliances, etc. However, the traditional ceramic heating elements mostly use high-thermal-conductivity alumina ceramics as a matrix, a conductive heat-resistant and refractory material as an inner electrode, to form a heating circuit, and form a novel high-heat-energy-saving heating element by co-firing through a series of special processes, which has the advantages of corrosion resistance, high-temperature-resistance, uniform temperature, long service life, etc.

At present, the traditional ceramic heating element is electrified to generate heat by itself to generate a temperature, and calibration values of temperature and voltage or a thermoelectric resistance value are used to reflect a heating temperature. However, in an actual heating process, due to the effect of many factors, an accurate temperature of the heating element cannot be obtained. If the temperature of the ceramic heating element decreases too much, heating or ignition is unreliable. If the temperature exceeds an upper limit, high-temperature burnout of a product is easily caused.

### SUMMARY

An object of the present disclosure is to provide an all-ceramic heating element, to solve the problem of poor precision of temperature control.

In order to achieve the object, the present disclosure provides an all-ceramic heating element, having an outer heating layer, an inner insulating layer and an inner heating layer, wherein the inner heating layer, the inner insulating layer and the outer heating layer are sequentially arranged from inside to outside, the outer heating layer is electrically connected to the inner heating layer, and the outer heating layer and the inner heating layer are made of ceramic materials with different material weight ratios.

In order to improve the sensitivity and accuracy of sensing temperature change and accurately measure the temperature of the all-ceramic heating element in real time, the outer heating layer includes an outer resistive layer, and the inner heating layer includes an inner resistive layer; the weight ratio of ceramic materials of the outer resistive layer and the inner resistive layer is:silicon nitride:silicon carbide:aluminum oxide:yttrium oxide:lanthanum oxide: molybdenum disilicide=(500-700):(100-300):(40-80):(50-90):(0-30):(500-800), and the ratios thereof for the outer resistive layer and the inner resistive layer are different.

In order to enhance the conductivity of the heating element, the outer heating layer further includes an outer conductive layer, and the inner heating layer further includes an inner conductive layer.

Further, the weight ratio of ceramic materials of the outer conductive layer is: silicon nitride:aluminium oxide:yttrium oxide:molybdenum disilicide=(500-700):(40-80):(50-90):(700-3000), thereby improving the conductivity of the outer conductive layer.

Further, the weight ratio of ceramic materials of the inner conductive layer is: silicon nitride:aluminium oxide:yttrium oxide:lanthanum oxide:molybdenum disilicide=(500-700):(40-80):(50-90):(0-30):(700-3000), thereby improving the conductivity of the inner conductive layer.

In order to isolate the inner heating layer from the outer heating layer, the weight ratio of ceramic materials of the inner insulating layer is: silicon nitride:aluminium oxide:yttrium oxide:lanthanum oxide:molybdenum disilicide=(500-700):(40-80):(50-90):(0-30):(10-800).

In order to facilitate connection of electrodes, the inner conductive layer is provided with a central electrode welding part, and the outer conductive layer is provided with a side electrode connecting part.

In order to meet the requirements of special application scenarios, such as preventing carbon accumulation and avoiding contact with conductive particles and a conductive wire mesh, an outer insulating layer is further included, and the outer insulating layer is wrapped on the outer conductive layer.

In an embodiment, the inner conductive layer, the inner resistive layer, the inner insulating layer, the outer resistive layer, the outer conductive layer and the outer insulating layer are sequentially arranged from inside to outside, and the whole heating element is a concentric spiral structure.

Further, the weight ratio of ceramic materials of the outer insulating layer is:silicon nitride:aluminium oxide:yttrium oxide:molybdenum disilicide=(500-700):(40-80):(50-90):(10-800).

Beneficial effects: the present disclosure has integrated heating and temperature-sensing functions, and is not affected by an external environment, for example, heat transfer of a combustion chamber or cold and hot air affects the temperature value of the heating element itself, so that the temperature value does not match a nominal voltage and temperature value, thereby affecting the ignition reliability thereof. According to the present disclosure, by means of the inner and outer heating structures, the greater the material difference between the two resistive layers, the more accurate the material/temperature difference electric potential. According to the principle of material/temperature difference electric potential: an electric potential generated at two ends of a single conductor due to temperature difference is the temperature difference electric potential, and when two different conductors are in contact with each other, if there is a certain temperature difference between two contacts, a material electric potential is generated. Heating or ignition is performed in a complex and variable operating environment, and the temperature is accurate and reliable. For example, as shown in FIG. 2, which shows a relationship between temperature difference across two ends of a heating element and thermal electric potential directly reflecting a linear relationship between the two, and the temperature difference is an actual temperature difference. According to the present disclosure, temperature values in a high-temperature region can be repeatedly provided, that facilitates the control circuit to adjust the voltage to achieve an ideal target temperature value, so that the temperature of the full-ceramic heating element is controlled in real time, and the purposes of reliable heating or ignition and reliable service life are achieved. The full-ceramic heating element has low dispersity and low hysteresis. The inventor performed a temperature test by spraying water to the outside of the full-ceramic heating element, and the measured temperature values change rapidly in real time.

### BRIEF DESCRIPTION OF THE DRAWINGS

FIG. 1 is a schematic structural diagram of Example 1 and Example 2; and

FIG. 2 is a linear graph of the relationship between temperature difference across two ends of a heating element and thermal electric potential.

Reference signs: 1. Inner conductive layer; 2. Inner resistive layer; 3. Inner insulating layer; 4. Outer resistive layer; 5. Outer conductive layer; 6. Outer insulating layer; 7. Communication hole; 8. Central electrode welding part; 9. Side electrode connecting part.

### DETAILED DESCRIPTION OF THE EMBODIMENTS

Specific embodiments of the present disclosure will be further described in detail with reference to the accompanying drawings hereafter. However, the present disclosure is not limited to these embodiments. Improvements made to the present disclosure without departing from the principle of the present disclosure also fall within the scope of protection of claims of the present disclosure.

An all-ceramic heating element, having: an outer heating layer, an inner insulating layer 3 and an inner heating layer, wherein the inner heating layer, the inner insulating layer 3 and the outer heating layer are sequentially arranged from inside to outside, the outer heating layer is electrically connected to the inner heating layer; the outer heating layer includes an outer resistive layer 4, and the inner heating layer includes an inner resistive layer 2; the weight ratio of ceramic materials of the outer resistive layer 4 and the inner resistive layer 2 is: silicon nitride:silicon carbide:aluminum oxide:yttrium oxide:lanthanum oxide:molybdenum disilicide=(500-700):(100-300):(40-80):(50-90):(0-30):(500-800), and the ratios thereof for the outer resistive layer 4 and the inner resistive layer 2 are different.

### Example 1

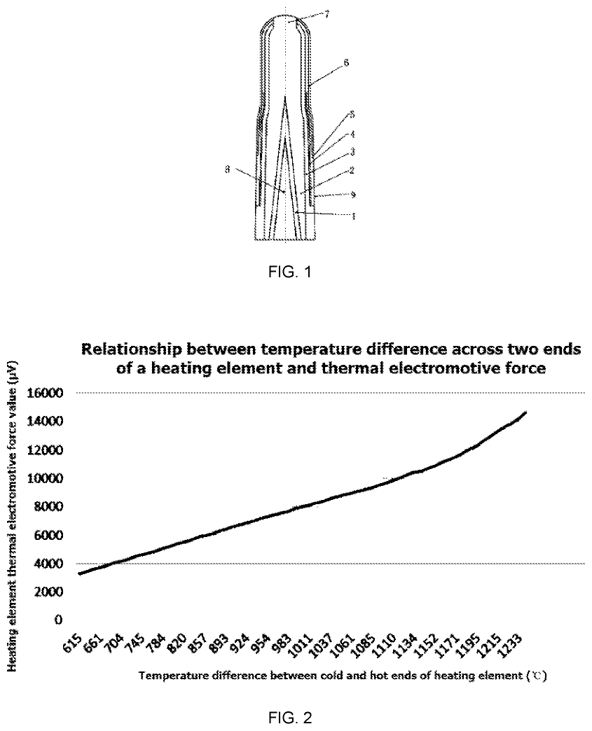

As shown in FIG. 1, an all-ceramic heating element includes, sequentially from inside to outside, an inner conductive layer 1, an inner resistive layer 2, an inner insulating layer 3, an outer resistive layer 4, an outer conductive layer 5 and an outer insulating layer 6, wherein the inner conductive layer 1 is located at the innermost part of the electric heating element, and the center of the bottom end of the inner conductive layer 1 is a central electrode welding part 8; the inner resistive layer 2 is divided into two sections, the diameter of the lower end is greater than the diameter of the upper end, and the lower end of the inner resistive layer 2 is wrapped outside the inner conductive layer 1; the inner insulating layer 3 is divided into three sections, in which the diameter of the middle section is greater than the diameter of the upper section, the diameter of the lower section is greater than the diameter of the middle section, the upper section is wrapped outside the upper section of the inner resistive layer 2, and the middle section and the lower section are wrapped outside the lower section of the inner resistive layer 2; the outer resistive layer 4 is divided into two sections, the upper section is wrapped outside the upper section of the inner insulating layer 3, the lower section is wrapped outside the middle section of the inner insulating layer 3, and the diameter of the lower section of the outer resistive layer 4 is smaller than the diameter of the lower section of the inner insulating layer 3; a communication hole 7 is provided at the top end of the upper section of the inner insulating layer 3, and a part of material of the outer resistive layer 4 is in communication with a part of material of the inner resistive layer 2 at the communication hole; the outer conductive layer 5 is wrapped outside the lower section of the outer resistive layer 4; the outer conductive layer 5 is divided into two sections, the diameter of the lower section is equal to the diameter of the lower section of the inner insulating layer 3, the diameter of the upper section of the outer conductive layer 5 is smaller than the diameter of the lower section thereof, and the lower section of the outer conductive layer 5 is a side electrode connecting part 9; the outer insulating layer 6 is wrapped outside the outer conductive layer 5; and the material of each layer is a ceramic material.

The weight ratio of ceramic materials of the outer resistive layer 4 is: silicon nitride:silicon carbide:aluminum oxide:yttrium oxide:lanthanum oxide: molybdenum disilicide=510:120:50:62:8:580.

The weight ratio of ceramic materials of the inner resistive layer 2 is: silicon nitride:silicon carbide:aluminum oxide:yttrium oxide:lanthanum oxide:molybdenum disilicide=680:260:75:80:27:780.

Constituent components of the outer insulating layer 6 and the outer conductive layer 5 contain four components: silicon nitride, aluminium oxide, yttrium oxide and molybdenum disilicide; and the effect of silicon nitride is to form a mesh structure, the effect of aluminium oxide and yttrium oxide is to adjust the mesh structure, and the effect of molybdenum disilicide is to form a conductive heating material.

The weight ratio of ceramic materials of the outer insulating layer 6 is: silicon nitride:aluminium oxide:yttrium oxide:molybdenum disilicide=600:50:60:200.

The weight ratio of ceramic materials of the inner insulating layer 3 is: silicon nitride:aluminium oxide:yttrium oxide:lanthanum oxide:molybdenum disilicide=580:60:70:10:600.

The weight ratio of ceramic materials of the outer conductive layer 5 is: silicon nitride:aluminium oxide:yttrium oxide molybdenum disilicide=650:58:70:1500.

The weight ratio of ceramic materials of the inner conductive layer 1 is: silicon nitride:aluminium oxide yttrium oxide:lanthanum oxide:molybdenum disilicide=600:60:75:15:1500.

### Example 2

Refer to the all-ceramic heating element of Example 1, Example 2 differs from Example 1 in that: the weight ratio of ceramic materials of the outer resistive layer 4 is: silicon nitride:silicon carbide:aluminum oxide:yttrium oxide:lanthanum oxide:molybdenum disilicide=660:260:70:80:20:700.

The weight ratio of ceramic materials of the inner resistive layer 2 is: silicon nitride:silicon carbide:aluminum oxide:yttrium oxide:lanthanum oxide molybdenum disilicide=550:110:50:55:10:550.

The weight ratio of ceramic materials of the outer insulating layer 6 is: silicon nitride:aluminium oxide:yttrium oxide molybdenum disilicide=680:70:80:700.

The weight ratio of ceramic materials of the inner insulating layer 3 is: silicon nitride:aluminium oxide:yttrium oxide:lanthanum oxide:molybdenum disilicide=680:45:80:20:50.

The weight ratio of ceramic materials of the outer conductive layer 5 is: silicon nitride:aluminium oxide:yttrium oxide:molybdenum disilicide=550:45:55:900.

The weight ratio of ceramic materials of the inner conductive layer 1 is: silicon nitride:aluminium oxide:yttrium oxide:lanthanum oxide:molybdenum disilicide=550:70:85:15:2500.

1. An all-ceramic heating element, characterized by: comprising:
an outer heating layer,
an inner insulating layer, and
an inner heating layer, wherein the inner heating layer, the inner insulating layer and the outer heating layer are sequentially arranged from inside to outside, the outer heating layer is electrically connected to the inner heating layer, and the outer heating layer and the inner heating layer are made of ceramic materials with different material weight ratios.

2. The all-ceramic heating element according to claim 1, wherein the outer heating layer comprises an outer resistive layer, and the inner heating layer comprises an inner resistive layer; the weight ratio of ceramic materials of the outer resistive layer and the inner resistive layer is: silicon nitride:silicon carbide:aluminum oxide:yttrium oxide:lanthanum oxide:molybdenum disilicide=(500-700):(100-300):(40-80):(50-90):(0-30):(500-800), and the ratios thereof for the outer resistive layer and the inner resistive layer are different.

3. The all-ceramic heating element according to claim 2, wherein the outer heating layer further comprises an outer conductive layer, and the inner heating layer further comprises an inner conductive layer.

4. The all-ceramic heating element according to claim 3, wherein the weight ratio of ceramic materials of the outer conductive layer is: silicon nitride:aluminium oxide:yttrium oxide:molybdenum disilicide=(500-700):(40-80):(50-90):(700-3000).

5. The all-ceramic heating element according to claim 4, wherein the weight ratio of ceramic materials of the inner conductive layer is: silicon nitride:aluminium oxide:yttrium oxide:lanthanum oxide:molybdenum disilicide=(500-700):(40-80):(50-90):(0-30):(700-3000).

6. The all-ceramic heating element according to claim 5, wherein the weight ratio of ceramic materials of the inner insulating layer is: silicon nitride:aluminium oxide:yttrium oxide:lanthanum oxide:molybdenum disilicide=(500-700):(40-80):(50-90):(0-30):(10-800).

7. The all-ceramic heating element according to claim 6, wherein the inner conductive layer is provided with a central electrode welding part, and the outer conductive layer is provided with a side electrode connecting part.

8. The all-ceramic heating element according to claim 7, further comprising an outer insulating layer, wherein the outer insulating layer is wrapped on the outer conductive layer.

9. The all-ceramic heating element according to claim 8, wherein the inner conductive layer, the inner resistive layer, the inner insulating layer, the outer resistive layer, the outer conductive layer and the outer insulating layer are sequentially arranged from inside to outside, and the whole heating element is a concentric spiral structure.

10. The all-ceramic heating element according to claim 8, wherein the weight ratio of ceramic materials of the outer insulating layer is: silicon nitride:aluminium oxide:yttrium oxide:molybdenum disilicide=(500-700):(40-80):(50-90):(10-800).

11. The all-ceramic heating element according to claim 3, wherein the weight ratio of ceramic materials of the inner conductive layer is: silicon nitride:aluminium oxide:yttrium oxide:lanthanum oxide:molybdenum disilicide=(500-700):(40-80):(50-90):(0-30):(700-3000).

12. The all-ceramic heating element according to claim 9, wherein the weight ratio of ceramic materials of the outer insulating layer is: silicon nitride:aluminium oxide:yttrium oxide:molybdenum disilicide=(500-700):(40-80):(50-90):(10-800).
